(19) United States
(12) Patent Application Publication
(10) Pub. No.: US 2023/0158731 A1
(43) Pub. Date: May 25, 2023

(54) Additives for Silicone Compositions

(71) Applicant: Sanford, L.P., Atlanta, GA (US)

(72) Inventors: Lien Phun, Cumming, GA (US); Roni Prater, Cumming, GA (US); Bryan Koepp, Cumming, GA (US); Joseph Wayne Kreft, Cohutta, GA (US)

(21) Appl. No.: 18/056,312

(22) Filed: Nov. 17, 2022

Related U.S. Application Data
(60) Provisional application No. 63/264,341, filed on Nov. 19, 2021.

(51) Int. Cl. B29C 64/106; C08L 83/06; C08L 29/04; C08L 29/14; C08K 3/34

(52) U.S. Cl. CPC B29C 64/106; C08L 83/06; C08L 29/04; C08L 29/14; C08K 3/34; B29K 2083/005

(57) ABSTRACT

A liquid additive delivery composition for introducing an additive into a curable silicone composition may include a liquid carrier and at least one additive. The liquid carrier may include one or both of polyvinyl acetate or polyvinyl alcohol.

### CROSS-REFERENCE TO RELATED APPLICATIONS

The present applications claims the benefit of U.S. Provisional Application No. 63/264,341, filed on Nov. 19, 2021, which is herein incorporated by reference in its entirety.

### TECHNICAL FIELD

The present disclosure relates generally to silicone compositions, and in particular, additives for silicone compositions.

### DESCRIPTION OF THE RELATED ART

Silicone compositions are used to prepare silicone products. For example, liquid or gel silicone compositions may be cast or molded, and cured to form shaped solid silicone products. Silicone compositions may include additives.

### SUMMARY

In aspects, the present disclosure describes a liquid additive delivery composition for introducing an additive into a curable silicone composition may include a liquid carrier and at least one additive. The liquid carrier may include one or both of polyvinyl acetate or polyvinyl alcohol.

In aspects, the present disclosure describes a method of adding an additive to a curable silicone composition. The method includes adding the liquid additive delivery composition to the curable silicone composition.

In aspects, the present disclosure describes a method of forming a liquid additive delivery composition for introducing an additive into a curable silicone composition. The method includes adding at least one additive to a liquid carrier comprising one or both of polyvinyl acetate or polyvinyl alcohol.

In aspects, the present disclosure describes a method of adding an additive to a curable silicone composition. The method includes adding a liquid additive delivery composition including one or both of polyvinyl acetate or polyvinyl alcohol to the curable silicone composition. The method includes adding at least one additive to the curable composition.

In aspects, the present disclosure describes a curable silicone composition include up to 15% by weight of a liquid additive delivery composition including at least one additive and a liquid carrier including one or both of polyvinyl acetate or polyvinyl alcohol.

In aspects, the present disclosure describes a cured silicone product formed by curing the curable silicone composition.

### DETAILED DESCRIPTION

The present disclosure describes silicone compositions, and additives for silicone compositions.

Solid silicone articles and products may be formed by curing precursor formulations, for example, curable silicone compositions. The curable silicone compositions may be placed in molds, or otherwise shaped into predetermined forms, followed by curing to form a cured object having a predetermined shape. In embodiments, the curing may be a room temperature curing, and the cured object may be formed by a user. For example, a child or another user may mold the curable silicone composition and allow the composition to cure at room temperature to form a toy or another object.

One or more additives may be added to curable silicone compositions, for example, colorants or other agents, to impart predetermined characteristics to the final cured silicone product. The base silicone product may be transparent, translucent, or opaque, and thus be colorless, white, or have an initial color. Using additives such as one or more colorants may be added in the composition to provide a predetermined color to the final product. Similarly, additives may also be used to provide visual effects or features, for example, sparkling, shining, shimmering, multiple colors, or other effects or features.

An additive may be added by a manufacturer, for example, before the curable silicone composition is used by a user. Alternatively, the additive may be added by a user, for example, based on the user's preference. As an example, the manufacturer may provide one or more optional additives with the curable silicone composition, and the user may select one or more of these additives to the added to the composition before molding. The user may also obtain an additive from a different source, and add the additive to the composition before molding.

Conventional additives may be in a solid form, for example, particulates or powders. The use of particulate or powder additives may not be desirable, in view of certain disadvantages associated with such forms of additives for users or manufacturers. For example, particulate or powder additives may unintentionally be dispersed or suspended in the ambient atmosphere, and may be unintentionally inhaled. Particulate or powder additives may also resist uniform mixing, or require additional stirring, agitation, or mixing time to be sufficiently dispersed or mixed throughout a volume of the composition.

Further, adding certain types of additives directly to a curable silicone composition may present disadvantages. For example, liquid colorants, or food coloring, to silicone formulations may not be well mixed or result in different phases rather than being uniformly incorporated into silicone formulations.

The present disclosure describes liquid additive delivery compositions as delivery systems for introducing additives into curable silicone compositions. Instead of adding powder additives, or other additives susceptible to dispersion or suspension in the air, additives may be dissolved, suspended, or mixed with a liquid carrier to form a liquid additive delivery composition. The liquid additive delivery composition can be stored, transported, and handled without resulting inhalation of particles or other disadvantages. For example, the liquid additive delivery composition may be compounded, mixed, or introduced into the curable silicone compositions.

Further, liquid additives may be introduced into the liquid additive delivery compositions, which may themselves be uniformly mixable with curable silicone compositions, so that ultimately the liquid additives (for example, food coloring) are well-mixed and uniformly incorporated into the curable silicone compositions, and ultimately, the cured silicone product.

In aspects, the present disclosure describes a liquid additive delivery composition for introducing an additive into a curable silicone composition may include a liquid carrier and at least one additive. Using a liquid carrier may facilitate uniform mixing, and may reduce or avoid spreading or dispersion of the additive outside the composition itself (for example, into a surrounding environment or air). The liquid carrier may include any suitable liquid base. In aspects, the liquid carrier may include a solvent that is compatible with the curable silicone composition, for example, being chemically compatible with the curable silicone composition. In aspects, the liquid carrier may include one or both of polyvinyl acetate or polyvinyl alcohol.

While liquid carriers and liquid additive delivery compositions are described, in aspects, gel carriers and gel additive delivery compositions may be used, instead of, or in addition to, liquid carriers and liquid additive delivery compositions. For example, a gelling agent may be added to a liquid carrier to form a gel carrier.

In aspects, the present disclosure describes a method of adding an additive to a curable silicone composition. The method includes adding the liquid additive delivery composition to the curable silicone composition. Thus, instead of adding an additive directly to the curable silicone composition, which may result in environmental distribution or dispersion, or result in insufficient mixing of the additive, the additive may be provided in a liquid carrier as a liquid additive delivery composition, and such a liquid additive delivery composition may be introduced into the curable silicone composition to facilitate incorporation and mixing of the additive into the curable silicone composition. The liquid additive delivery composition may be provided in a ready-to-use form to a user, such that the user only simply needs to add a desired amount of the delivery composition to the silicone composition. Adding the delivery composition instead of the additive itself may also assist the user in controlling the amount of additive incorporated. For example, if the additive is initially in a fine particulate or powdered form, it may be somewhat difficult for the user to measure a small amount of the additive. However, if the additive is a part of the delivery composition, the user may find it easier to measure the delivery composition, which would provide a greater volume or mass to be measured relative to the smaller amount of the additive.

In aspects, the present disclosure describes a method of forming a liquid additive delivery composition for introducing an additive into a curable silicone composition. The method includes adding at least one additive to a liquid carrier comprising one or both of polyvinyl acetate or polyvinyl alcohol. A manufacturer may form a number of different liquid additive delivery compositions, each including an additive or a mixture of additives, and the user may user a predetermined volume or mass of one or more of the different liquid additive delivery compositions. Alternatively, the manufacturer may provide one or more liquid carriers and additives separately to the user, and the user may combine additive and liquid carriers to prepare a liquid additive delivery composition to be ultimately added to the curable silicone composition.

In aspects, the present disclosure describes a method of adding an additive to a curable silicone composition. The method includes adding a liquid additive delivery composition including one or both of polyvinyl acetate or polyvinyl alcohol to the curable silicone composition. The method includes adding at least one additive to the curable composition. For example, adding the liquid additive delivery composition causes one or more additive carried by a liquid carrier of the liquid additive delivery composition to be incorporated into the curable composition.

In aspects, the present disclosure describes a curable silicone composition include up to 15% by weight of a liquid additive delivery composition including at least one additive and a liquid carrier including one or both of polyvinyl acetate or polyvinyl alcohol.

In aspects, the present disclosure describes a cured silicone product formed by curing the curable silicone composition. The cured silicone product may include a toy, or any other product. In comparison with cured silicone products formed by curing silicone products in which a solid, powdered, or particulate additive is directly incorporated, curable silicone products formed by introducing an additive through a liquid additive delivery composition may exhibit a more uniform matrix through the product, for example, being more uniformly dispersed or mixed.

The precursor curable compositions may include liquid or gel silicone compositions, for example, compositions that are cast or molded in a predetermined shape. The curing may be a result of cross-linking, chemical, or catalyzed interactions between two or more components of the silicone compositions, or a by being exposed to an energy source, such as radiation curing or thermal curing. The cured composition will include additives introduced via the liquid additive delivery composition.

In aspects, curing may be initiated by mixing a two-part formulation. In some such aspects, the curing may be performed at room temperature. In some such aspects, the liquid additive delivery composition may be added, introduced, or mixed, into one or both parts (for example, Part A and Part B) of the two-part formulation separately, before the parts are mixed to initiate curing. In other aspects, the liquid additive delivery composition may be added to a mixed two-part composition shortly after mixing and before curing has substantially progressed. In some aspects, a first liquid additive delivery composition may be added to at least one of the two parts before mixing, and a second liquid additive delivery composition may be added to the mixture shortly after mixing, for example, before curing has substantially progressed.

In some aspects, the same liquid additive delivery composition may be added in the same or different concentrations to each part of the two-part formulation before mixing. In other aspects, different liquid additive delivery compositions (for example, differing in the liquid carrier, or qualitatively or quantitatively differing in the additives present) may be added to the different parts of the formulation.

In some aspects, whether a single-part, two-part, or multi-part formulation is used, the liquid additive delivery composition may be added in stages, and in the same or different volumes or concentrations, for example, before or during curing. In some aspects, different liquid additive delivery compositions may be introduced into the formulation at different stages (before curing or during curing).

In aspects, the liquid carrier includes an aqueous carrier, or an organic carrier. The carrier may be selected so that the carrier does not substantially interfere with curing of the silicone composition, and so that the carrier tends to be uniformly incorporated into the silicone composition. For example, the carrier may be chemically compatible with silicone, for example, via hydrogen bonding, or other chemical interactions. The carrier may be selected such that the carrier tends to “wet” one or more additives, such that the additive does not tend to separate out or agglomerate in the carrier. The carrier may include one or more monomers, oligomers, or polymers. The carrier may include a polymeric liquid. In some aspects, the liquid carrier includes one or both of a polyvinyl alcohol solution or a polyvinyl acetate solution.

The liquid carrier may include any suitable concentration of polyvinyl alcohol or polyvinyl acetate. For example, the liquid carrier may include at least 10% by weight, at least 25% by weight, at least 50% by weight, at least 75% by weight, or at least 90% by weight, of polyvinyl alcohol or polyvinyl acetate, alone or in combination. The liquid carrier may include 90% by weight or less, 75% by weight or less, 50% by weight or less, 25% by weight or less, or 10% by weight or less, of polyvinyl alcohol or polyvinyl acetate, alone or in combination. The liquid carrier may include 10% to 90% by weight, or 25% to 75% by weight, or 25% to 50% by weight, or 50% to 75% by weight, or 50% to 90% by weight, or 75% by 90% by weight, of polyvinyl alcohol or polyvinyl acetate, alone or in combination.

In some aspects, the liquid additive delivery composition includes a combination of polyvinyl alcohol and polyvinyl acetate. Additives, colorants, or special effects may be added to the liquid additive delivery composition, and the liquid additive delivery composition with one or more additives may be added to a curable silicone composition for curing into a cured silicone product. Thus, providing colorants or special effect additives in the liquid additive delivery compositions allows imparting predetermined colors, special effects, or other properties to the silicone products.

In aspects, the curable silicone composition includes at least 1% by weight, at least 2% by weight, at least 5% by weight, at least 8% by weight, at least 10% by weight, at least 12% by weight, at least 15% by weight, or at least 25% by weight, of the liquid additive delivery composition. In aspects, the curable silicone composition includes 30% by weight or less, 25% by weight or less, 15% by weight or less, 12% by weight or less, 10% by weight or less, 8% by weight or less, 5% by weight or less, or 2% by weight by weight or less, of the liquid additive delivery composition. In aspects, the curable silicone composition includes 1% to 30% by weight, 1% to 25% by weight, 1% to 15% by weight, 1% to 12% by weight, 1% to 10% by weight, 1% to 8% by weight, or 1% to 5% by weight, 5% to 25% by weight, or 5% to 15% by weight, or 5% to 25% by weight, of the liquid additive delivery composition.

In aspects, a polyvinyl acetate emulsion can be used as a ‘solvent’ or carrier in order to incorporate additives into a curable silicone composition.

In aspects, the liquid carrier is an aqueous carrier or an organic carrier.

In aspects, the liquid additive delivery composition includes a solution, a mixture, an emulsion, or a suspension of one or both of polyvinyl acetate or polyvinyl alcohol. In aspects, the liquid carrier of the liquid additive delivery composition consists essentially of or consists of a polyvinyl acetate solution. In aspects, the liquid carrier of the liquid additive delivery composition consists essentially of or consists of a polyvinyl alcohol solution.

In aspects, the at least one additive includes a powder additive, a solid additive, a gel additive, or a liquid additive.

In aspects, the at least one additive comprises a food colorant. In some such aspects, the food colorant is a liquid colorant or a powdered colorant.

In aspects, the at least one additive comprises a special effect additive.

It was surprisingly found that the cure time as well as the texture of the final silicone product is not impacted, even if up to 15% by weight of the polyvinyl acetate or polyvinyl alcohol solution is incorporated into the curable silicone formulation. In aspects, the curable silicone composition includes at least 1% by weight, at least 2% by weight, at least 5% by weight, at least 8% by weight, at least 10% by weight, at least 12% by weight, at least 15% by weight, or at least 25% by weight, of polyvinyl acetate or polyvinyl alcohol, alone or in combination. In aspects, the curable silicone composition includes 30% by weight or less, 25% by weight or less, 15% by weight or less, 12% by weight or less, 10% by weight or less, 8% by weight or less, 5% by weight or less, or 2% by weight by weight or less, of polyvinyl acetate or polyvinyl alcohol, alone or in combination. In aspects, the curable silicone composition includes 1% to 30% by weight, 1% to 25% by weight, 1% to 15% by weight, 1% to 12% by weight, 1% to 10% by weight, 1% to 8% by weight, or 1% to 5% by weight, 5% to 25% by weight, or 5% to 15% by weight, or 5% to 25% by weight, of polyvinyl acetate or polyvinyl alcohol, alone or in combination.

When polyvinyl acetate and polyvinyl alcohol are present in combination, any suitable relative ratio by weight by may be used, for example, 1:10, 1:8, 1:5, 1:2, 1:1, 2:1, 5:1, 8:10, or 10:1 of polyvinyl acetate:polyvinyl alcohol. Polyvinyl acetate may be present in a concentration of at least 5% by weight, at least 10% by weight, at least 25% by weight, at least 50% by weight, at least 75% by weight, or at least 100% by weight, relative to polyvinyl alcohol. Polyvinyl alcohol may be present in a concentration of at least 5% by weight, at least 10% by weight, at least 25% by weight, at least 50% by weight, at least 75% by weight, or at least 100% by weight, relative to polyvinyl acetate.

In aspects, an additive is first mixed with a liquid carrier to form the liquid additive delivery composition, and the liquid additive delivery composition is then mixed with the curable silicone composition. The liquid carrier may include one or both of a polyvinyl alcohol or a polyvinyl acetate solution, emulsion, or suspension.

In aspects, an additive and a liquid carrier are simultaneously mixed with the curable silicone composition, and the presence of the liquid carrier facilitates the incorporation of the additive into the curable silicone composition.

While the disclosure has been described with reference to a number of embodiments, it will be understood by those skilled in the art that the invention is not limited to such disclosed embodiments. Rather, the invention can be modified to incorporate any number of variations, alterations, substitutions, or equivalent arrangements not described herein, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A liquid additive delivery composition for introducing an additive into a curable silicone composition, the liquid additive delivery composition comprising:
a liquid carrier; and
at least one additive.

2. The liquid additive delivery composition of claim 1, wherein the liquid carrier comprises one or both of polyvinyl acetate or polyvinyl alcohol.

3. The liquid additive delivery composition of claim 1, wherein the liquid carrier consists of a polyvinyl acetate solution.

4. The liquid additive delivery composition of claim 1, wherein the liquid carrier consists of a polyvinyl alcohol solution.

5. The liquid additive delivery composition of claim 1, wherein the liquid carrier is an aqueous carrier or an organic carrier.

6. The liquid additive delivery composition of claim 1, wherein the liquid additive delivery composition comprises a solution, a mixture, an emulsion, or a suspension of one or both of polyvinyl acetate or polyvinyl alcohol.

7. The liquid additive delivery composition of claim 1, wherein the at least one additive comprises a powder additive, a particulate additive, a solid additive, a gel additive, or a liquid additive.

8. The liquid additive delivery composition of claim 1, wherein the at least one additive comprises a food colorant.

9. The liquid additive delivery composition of claim 1, wherein the at least one additive comprises a special effect additive.

10. A curable silicone composition comprising up to 15% by weight of the liquid additive delivery composition of claim 1.

11. A cured silicone product formed by curing the curable silicone composition of claim 10.

12. A method of forming a liquid additive delivery composition for introducing an additive into a curable silicone composition, the method comprising:
adding the additive to a liquid carrier.

13. The method of claim 12, wherein the liquid carrier comprises one or both of polyvinyl acetate or polyvinyl alcohol.

14. The method of claim 13, wherein the liquid carrier consists of a polyvinyl acetate solution.

15. The method of claim 13, wherein the liquid carrier consists of a polyvinyl alcohol solution.

16. A method of adding at least one additive to a curable silicone composition, the method comprising:
adding a liquid additive delivery composition to the curable silicone composition,
wherein the liquid additive delivery composition comprises a liquid carrier and the at least one additive.

17. The method of claim 16, wherein the liquid carrier comprises one or both of polyvinyl acetate or polyvinyl alcohol.

18. The method of claim 17, wherein curable silicone composition comprises up to 15% by weight of the liquid additive delivery composition.

19. The method of claim 16, further comprising adding the additive to the liquid carrier to form the liquid additive delivery composition.

20. The method of claim 16, wherein the at least one additive comprises a powder additive, a particulate additive, a solid additive, a gel additive, or a liquid additive.
